(19) United States
(12) Patent Application Publication
(10) Pub. No.: US 2021/0065243 A1
(43) Pub. Date: Mar. 4, 2021

(54) AFFILIATE DEVICE HAVING PREPROGRAMMED CONTENT

(71) Applicant: Spencer Derman, Brooklyn, NY (US)

(72) Inventor: Spencer Derman, Brooklyn, NY (US)

(21) Appl. No.: 16/551,636

(22) Filed: Aug. 26, 2019

(51) Int. Cl. G06Q 30/02

(52) U.S. Cl. CPC G06Q 30/0267; G06Q 30/0277; G06Q 30/0209; G06Q 30/0214

(57) ABSTRACT

A device pre-programmed or downloaded with content wherein the owner of the device provides a user with the device and when the user of the device makes a purchase or views certain material, the owner of the device receives incentives such as cash, prizes or points that leads to rewards, and the user of the device also receives discounts, cash prizes or points that lead to rewards.

### RELATED APPLICATIONS

The present application claims priority to provisional patent application 62/722,915.

### FIELD OF THE INVENTION

The present invention relates to devices that are pre-programmed or downloaded with content wherein the owner of the device provides a user with the device and when the user of the device makes a purchase or views certain material, the owner of the device receives incentives such as cash, prizes or points that leads to rewards, and the user of the device also receives discounts, cash prizes or points that lead to rewards.

### BACKGROUND OF THE INVENTION

In the past a user could be using a cell phone or computer and go onto certain sites or apps where the user may receive a discount for purchasing a product, or may receive points that lead to a reward for watching a website. The person who sold the cell phone or computer does not receive any compensation for any purchases that the user makes on any websites that the user views. This is also true with the person who sells a user a computer, car, house, radio, etc.

### SUMMARY OF THE INVENTION

The present invention relates to an affiliate pre-programmed device. It is an object of the present invention for the device to be a cell phone. A cell phone company sells a cell phone to a user. The cell phone is pre-programmed with pop-up ads, games, and websites. It is an object for the cell phone user to watch the pop up ads, and potentially make purchases based on the ads. When the user makes purchase based on the ads, the user receives discounts, cash back or other rewards. The cell phone company receives a commission from the purchases or views made by the user from the cell phone. It is an object of the present invention for the cell phone company to provide the cell phone to the user for free or at a discounted rate.

It is an object of the present invention for the user to receive ad commissions based on auto-ads, ads on websites and product placement ads off of the device.

It is an object of the present invention for the user to play the pre-programmed or downloaded games that are on the cell phone. The user who plays the games receives rewards for playing the games. It is an object of the present invention for the Company to receive rewards every time the user plays the games on the cell phone.

It is an object of the present invention for the user to visit websites pre-programmed or downloaded into the cell phone. The user who visits the websites receives rewards for visiting and exploring the websites. It is an object of the present invention for the Company to receive rewards every time the user visits the websites on the cell phone.

The present invention relates to an affiliate pre-programmed device wherein the device is a computer. A computer company sells a computer to a user. The computer is pre-programmed with pop-up ads, games, and websites. It is an object for the computer user to watch the pop-up ads, and potentially make purchases based on the ads. When the user makes purchase based on the ads, the user receives discounts, cash back or other rewards. The computer company receives a commission from the purchases or views made by the user from the computer. It is an object of the present invention for the computer company to provide the computer to the user for free or at a discounted rate.

It is an object of the present invention for the user to play the pre-programmed or downloaded games that are on the computer. The user who plays the games receives rewards for playing the games. It is an object of the present invention for the Company to receive rewards every time the user plays the games on the computer.

It is an object of the present invention for the user to visit websites pre-programmed or downloaded into the computer. The user who visits the websites receives rewards for visiting and exploring the websites. It is an object of the present invention for the Company to receive rewards every time the user visits the websites on the computer.

The present invention relates to an affiliate preprogrammed device that comprises a television, radio. A company sells a television or radio to a user. The radio or television is preprogrammed with pop up ads, games, and websites. It is an object for the television or radio user to watch or listen to the pop-up ads, and potentially make purchases based on the ads. When the user makes purchase based on the ads, the user receives discounts, cash back or other rewards. The company that sold the television or radio receives a commission from the purchases or views made by the user from the television or radio. It is an object of the present invention for the company that sells the television or radio to provide the television to the user for free or at a discounted rate.

It is an object of the present invention for the user to play the pre-programmed or downloaded games that are on the television or radio. The user who plays the games receives rewards for playing the games. It is an object of the present invention for the Company to receive rewards every time the user plays the games on the television or radio.

It is an object of the present invention for the user to visit websites pre-programmed or downloaded into the television or radio. The user who visits the websites receives rewards for visiting and exploring the websites. It is an object of the present invention for the Company to receive rewards every time the user visits the websites on the television or radio.

The present invention relates to an affiliate real estate device, wherein a company provides a house or apartment to a user for free or a discounted value and every time a user uses devices in the apartment or house the person who lives in the dwelling gets rewards and the real estate company receives rewards. For example if the person who lives in the dwelling purchases solar panels, then that person would receive a reward and the seller of the dwelling would receive a reward.

Further, the dwelling would have computers, televisions, phones, all where purchases can be made, wherein every time a purchase is made by the user, the seller of the dwelling receives a reward. It is an object of the present invention for any or all of the device to be pre-programmed or downloaded with specific sites, phone numbers or other ads to assist the person in making specific purchases.

It is an object of the present invention for the device sold to the user to be a car, which comprises preprogrammed ads in the radio or computers that are part of the car.

The present invention relates to an affiliate pre-programmed or downloaded device, wherein the device is a game console. The game console company sells a game console to user. The game console is pre-programmed with pop-up ads, games, websites. It is an object of the present invention for the game console user to watch the pop-up ads, and potentially make purchases based on the ads. When the user makes purchases based on the ads, the user receives discounts, cash back or other rewards. The game console company receives a commission for the purchasers or views made by the user from the game console. It is an object of the present invention for the game console company to provide the game console to the user for free or at a discounted rate.

It is an object of the present invention for the above devices to be pre-programmed with something that captures part of the revenue to the user from any and all revenue made on the phone or other devices, such as ad views, ad clicks, pop-up ads, purchases made on the device, applications downloaded on the device.

1. A device having pre-programmed or downloaded with content comprising:
said device provided with pre-programmed or downloaded content;
wherein owner of said device provides a user with said device;
when user of said device makes a purchase or views certain material, said owner of said device receives incentives such as cash, prizes or points that leads to rewards, and said user of said device also receives discounts, cash prizes or points that lead to rewards.

2. An affiliate pre-programmed device comprising:
a cell phone or computer;
said cell phone or computer company sells said cell phone or computer to a user;
said cell phone or computer is pre-programmed with pop-up ads, games, and websites;
said cellphone or computer providing pop up ads to a user to watch and potentially make purchases based on said ads;
said user receiving discounts, cash back or other rewards based on purchases made on said ads;
said cell phone or computer company receiving a commission from said purchases or views made by said user from said cell phone or computer.

3. The affiliated pre-programmed device of claim 1 wherein said cell phone or computer company provides said cell phone or computer to said user for free or at a discounted rate.

4. The affiliated pre-programmed device of claim 1 wherein said user receives ad commissions based on auto-ads, ads on websites and product placement ads off said device.

5. The affiliated pre-programmed device of claim 1 wherein said device contains downloaded games that are played on said cell phone or said computer by said user, wherein said user who plays said games receives rewards for playing said game on said cellphone or said computer.

6. The affiliated pre-programmed device of claim 5 wherein said company receives rewards every time said user plays said games on said cell phone or said computer.

7. The affiliated pre-programmed device of claim 1 wherein websites are pre-programmed or downloaded into said cell phone or said computer.

8. The device of claim 7 wherein when said user visits said websites said user receives rewards and said company receives rewards every time said user visits said websites on said cell phone or said computer.

9. An affiliate pre-programmed device comprising:
a television or radio;
said television or radio comprising pre-programmed pop-ads, games, and websites;
said television or radio adapted so that a user can watch or listen to said pop-up ads and make purchases based on said ads;
said user receives discounts, cash back or other rewards based on purchases on said ads;
a company selling said television or radio with said ads, games and websites receives commission from purchases or views made by said user on said television or radio.

10. The pre-programmed device of claim 9 wherein said company that sells said television or radio provides said television or radio to said user for free or at a discounted rate.

11. The pre-programmed device of claim 9 wherein said device comprises pre-programmed or downloaded games;
said user who plays said games receives rewards for playing said games and said company receives rewards every time said user plays said games on said television or radio.

12. The pre-programmed device of claim 9 wherein said device comprises websites pre-programmed or downloaded into said television or said radio wherein said user who visits said websites receives rewards for visiting and exploring said websites and said company receives rewards every time said user visits said websites on said television or radio.

13. The device of claim 1 wherein said device is provided in conjunction with purchasing or renting a house, and a reward is given to a real estate agent who assisted in sale or renting of said house, when a purchase is made on said device.

14. The device of claim 1 wherein said device is used in conjunction with a car which has preprogrammed ads in radio or computers of said car.

15. The device of claim 1 wherein said device is a game console.

16. The device of claim 1 wherein said device is pre-programmed with something that captures part of revenue to said user from any and all revenue made on said devices, such as ad views, ad dicks, pop-up ads, purchases made on said device, or applications downloaded on said device.
